(19) United States
(12) Patent Application Publication
(10) Pub. No.: US 2026/0098970 A1
(43) Pub. Date: Apr. 9, 2026

(54) PRECISE POSITIONING FOR INTERMITTENTLY OPERATED GNSS DEVICES

(71) Applicant: Tupaia Ltd., Ramat-Hasharon (IL)

(72) Inventors: Jacob SCHEIM, Pardess-Hanna (IL); Leonid PANTALER, Haifa (IL); Nadav LAVI, Ramat-Hasharon (IL)

(73) Assignee: Tupaia Ltd., Ramat-Hasharon (IL)

(21) Appl. No.: 18/910,827

(22) Filed: Oct. 9, 2024

(51) Int. Cl. G01S 19/34; G01S 19/09; G01S 19/24

(52) U.S. Cl. CPC G01S 19/34; G01S 19/09; G01S 19/24

(57) ABSTRACT

A method for operating an intermittently operating Internet of Things (IoT) device having a global navigation satellite system (GNSS) that includes an analog receiver coupled to a GNSS measurements engine, a processing circuit, and a communications interface, comprising: under control of the processing circuit, starting operation of the GNSS to collect GNSS measurements; under control of the processing circuit, once a first prescribed quantity of measurements are collected, enabling operation of the communications interface; after the communications interface is enabled, transmitting, via the communications interface, ones of a total prescribed quantity of the collected GNSS measurements, wherein the total prescribed quantity includes the first prescribed quantity; and under control of the processing circuit, turning off the GNSS once a prescribed condition has been met, wherein the prescribed condition a total prescribed quantity of GNSS measurements have been collected or a total prescribed quantity of GNSS measurements have been transmitted.

### TECHNICAL FIELD

This invention relates to global navigation satellite system (GNSS) devices, and more specifically, to GNSS devices that operate only intermittently.

### BACKGROUND

Traditional GNSS devices have available to them a relatively large computing power and fairly robust power availability, e.g., those in cell phones or in dedicated global positioning (GPS) devices. Thus, they can operate continuously and perform the complicated calculations required to determine an accurate position, e.g., using real-time kinematic (RTK) techniques. RTK techniques require raw measurements received from a nearby static reference station with a predetermined accurate location. Thus, such traditional GNSS devices also have a communication unit that connects them, e.g., wirelessly, to receive the raw measurements. Such a communication unit requires additional power beyond that required of the basic GNSS device for positioning without correction. RTK techniques have been able to achieve a location that is accurate to within a few centimeters.

In contrast to such traditional GNSS devices, there are Internet of Things (IoT) devices that have minimal computing power and a puny power availability, e.g., from a small battery or energy harvesting. Furthermore, such IoT devices tend to operate intermittently, typically being asleep unless there is a reason for them to be awake to perform some action. Therefore, it is problematic for IoT devices to operate a high-quality GNSS device of the traditional type and they are typically unable to determine their location with accuracy. Nevertheless, there are applications where accurately determining the position of an IoT device is highly desirable and such needs to be achieved within the minimal computing power and power available to it.

### SUMMARY OF THE DISCLOSURE

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for operating an intermittently operating Internet of Things (IoT) device having a global navigation satellite system (GNSS) that includes an analog receiver coupled to a GNSS measurements engine, a processing circuit, and a communications interface. The method comprises: under control of the processing circuit, starting operation of the GNSS to collect GNSS measurements; under control of the processing circuit, once a first prescribed quantity of measurements are collected, enabling operation of the communications interface; after the communications interface is enabled, transmitting, via the communications interface, ones of a total prescribed quantity of the collected GNSS measurements, wherein the total prescribed quantity includes the first prescribed quantity; and under control of the processing circuit, turning off the GNSS once a prescribed condition has been met.

Certain embodiments disclosed herein include a method for determining, in a cloud, a current position for an intermittently operating Internet of Things (IoT) device, comprising: receiving, in the cloud, global navigation satellite system (GNSS) measurements from the IoT device for a time period; and determining, in the cloud, a current position for the IoT device based on the received GNSS measurements.

Certain embodiments disclosed herein include an intermittently operating Internet of Things (IoT) device having a global navigation satellite system (GNSS), comprising: an analog receiver; a GNSS measurements engine coupled to the analog receiver, a processing circuit; and a communications interface; wherein the intermittently operating Internet of Things (IoT) device is operable, under control of the processing circuit, to: start operation of the GNSS to collect GNSS measurements; enable operation of the communications interface once a first prescribed quantity of measurements are collected; and transmit, via the communications interface, ones of the collected GNSS measurements.

### BRIEF DESCRIPTION OF THE DRAWING

In the drawing:

FIG. 1 shows a portion of an illustrative structure of an IoT GNSS device in accordance with an embodiment of the disclosure;

FIG. 2 shows a more comprehensive view of the IoT GNSS device of FIG. 1;

FIG. 3 shows an operational scheduling arrangement for the IoT GNSS device of FIG. 1 in accordance with an embodiment of the disclosure;

FIG. 4 shows an illustrative system arranged in accordance with the principles of the disclosure for determining a location for an IoT GNSS device that does not determine its own position but instead supplies the GNSS measurements it takes to a remote compute center, e.g., in the cloud, which determines an actual location for the GNSS IoT device;

FIG. 5 shows the illustrative system of FIG. 4 with further detail provided for an embodiment; and

FIG. 6 shows an illustrative system according to an embodiment which can be used to implement any of the devices or processing described herein.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In accordance with the principles of the disclosure, position calculations for intermittently operating Internet of Things (IoT) devices are performed in the cloud based on measurements collected by the IoT device and transmitted to the cloud. Power usage may be reduced, or even optimized, by controlling the operation of the GNSS measurements engine and the connectivity unit of the IoT device. Furthermore, the cloud may subsequently develop from the standard position that it initially develops a more accurate position by employing real-time kinematic (RTK) or similar enhancement or augmentation techniques. To that end, data from reference stations may be received at the cloud to be employed in the enhancement of the position. Because of delays that result in the cloud receiving the measurements from the IoT device, the data from the reference stations may be buffered to enable the reference station data to be properly aligned in time to the measurements. The resulting position of one or more of the IoT devices may be transmitted for use by a user device, e.g., an application thereon. In order to cost-effectively utilize the cloud, the number of compute units, each of which may provide a position at a time instant for one of the IoT devices, may be dynamically controlled, e.g., based on the anticipated number of IoT devices that are expected to be awake, i.e., active, during a period of time. This may require buffering of the data arriving from the IoT devices.

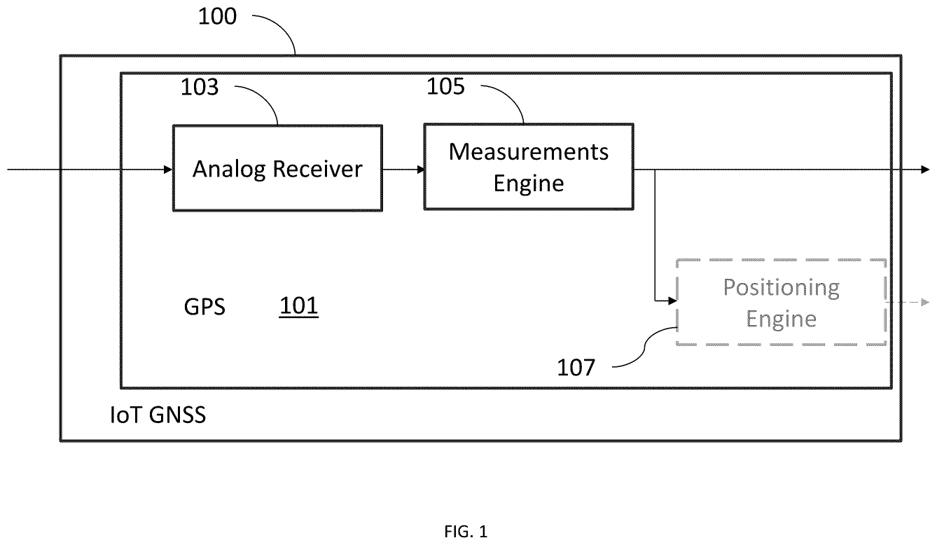

FIG. 1 shows a portion of an illustrative structure of IoT GNSS device 100 in accordance with an embodiment of the disclosure. IoT GNSS device 100 includes GPS unit 101 which in turn includes analog receiver 103, measurements engine 105, and optional positioning engine 107. Note that GPS unit 101 is not limited to GPS, i.e., to employing just GPS satellites of the United States, but rather it may employ any GNSS satellites, e.g., GPS, Glonass, Beidou, Galileo, and the like. Furthermore, signals from more than one type of satellite may be processed by GPS unit 101. Thus, the nomenclature GPS is simply for convenience as used in conventional parlance and is not intended as a limitation to GPS.

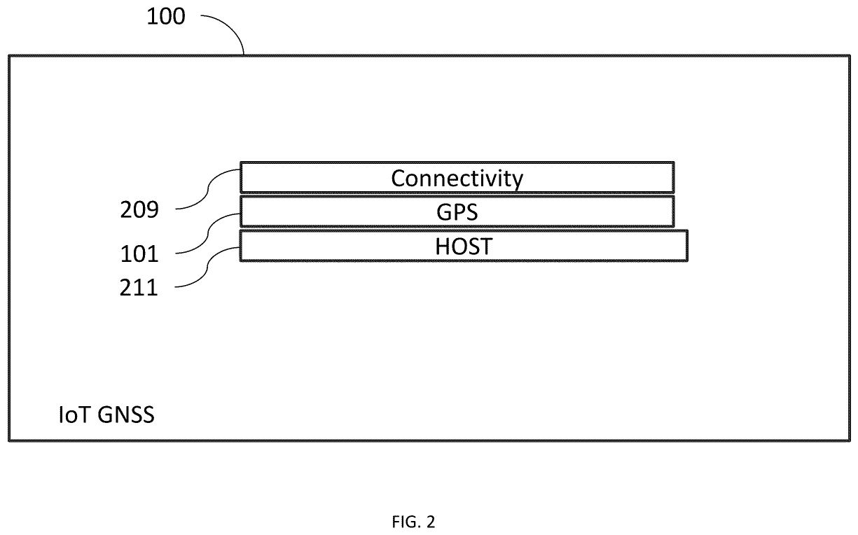

Analog receiver 103 and measurements engine 105 are conventional. Optional positioning engine 107 is typically not employed in this disclosure, e.g., because using it would consume power that cannot be spared, but it is shown because it may be incorporated in a chip that would be included in IoT GNSS 100 for providing analog receiver 103 and measurements engine 105. As such, for typical operation of IoT GNSS 100 in accordance with this disclosure, positioning engine 107 would be disabled. The output of measurement engine 105 is supplied to a connectivity unit, shown in FIG. 2, capable of wireless communication with a remote entity so as to ultimately provide the measurements generated by measurements engine 105 to the cloud. The input to analog receiver 103 are signals from satellites received by at least one antenna (not shown).

FIG. 2 shows a more comprehensive view of IoT GNSS device 100. Shown in FIG. 2 are GPS unit 101 (FIG. 1), connectivity unit 209 and host 211. Connectivity unit 209 provides to GNSS device 100 the ability for wireless communication with a remote entity. This may be achieved by any wireless communication arrangement, e.g., cellular, Wi-Fi, Bluetooth, Bluetooth low energy (BLE), Zigbee, and so forth. Host 211 is the underlying processor or controller that controls overall operation of IoT GNSS 100.

As indicated above, power usage by IoT GNSS device 100 may be reduced, or even optimized, by controlling the operation of GPS 101 and connectivity unit 209 of IoT GNSS device 100. In this regard, it should be appreciated that IoT GNSS device 100 is not operated continuously but rather is operated in a periodical or aperiodic manner. Thus, IoT GNSS device 100 is sleeping, then wakes to take GPS measurements and send them to the cloud, and then goes back to sleep. Indeed, in some applications, IoT GNSS device 100 may be sleeping most of the time.

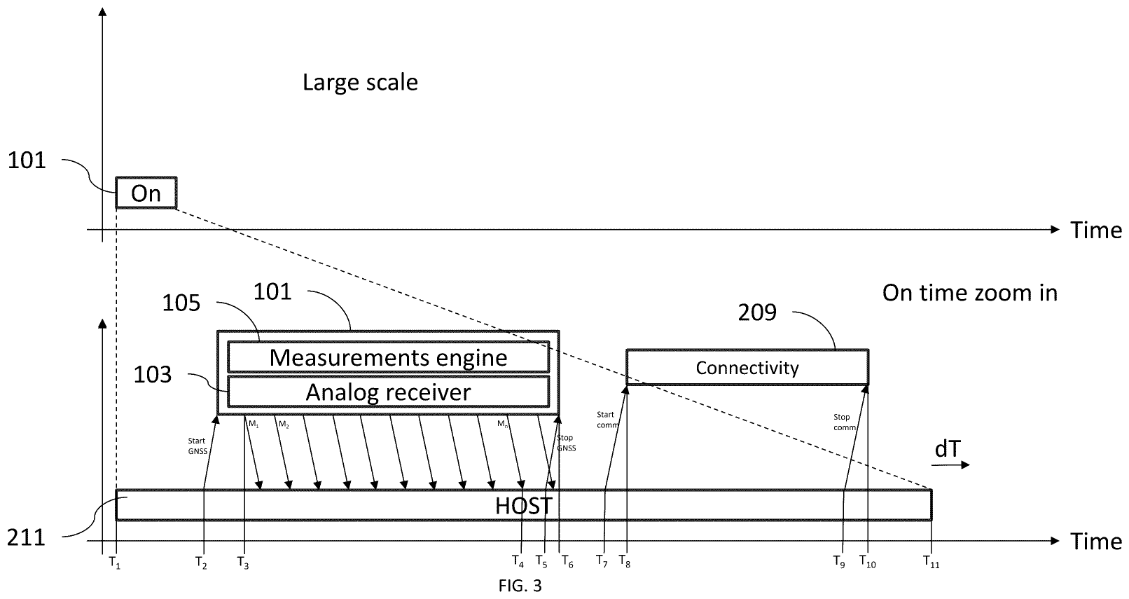

To this end, FIG. 3 shows an operational scheduling arrangement for IoT GNSS device 100 in accordance with an embodiment of the disclosure. The top portion of FIG. 3 shows a large-scale view where IoT GNSS device 100 is on for a brief period of time and then is off. The bottom portion of FIG. 3 shows a zoomed-in view of the sequencing and operation of the components of IoT GNSS device 100 during the on time of the top portion. The time scale is illustrative only and not representative of actual time for any embodiment.

Operation of IoT GNSS device 100 begins at T₁ and ends at T₁₁. Depending on the application, one or more types of triggers for beginning to turn IoT GNSS device 100 may be employed. Some such triggers may be arrival of a prescribed time, e.g., as measured by a timer that is constantly powered, detection of a certain signal by a sensor that is constantly powered, accumulation of sufficient power through energy harvesting to be able to operate IoT GNSS device 100, and the like.

At T₁ operation of IoT GNSS device 100 begins with operation of host 211. Host 211 does some initial processing and then at time T₂ it signals GPS unit 101 to start operation. From time T₂ until time T₃ GPS unit 103 performs its initial functions until at time T₃ it begins supplying its first measurement M₁ to host 211. Operation between T₂ to T₃ by GPS unit 101 includes initial acquisition and tracking functions until a valid measurement M₁ is obtained. Each measurement M is typically a set of measurements for one epoch. The operating system of IoT GNSS device 101 may determine how often an epoch occurs. For example, in some embodiments, an epoch may occur once or twice per second while in other embodiments, an epoch may occur more often than that. As is known to those of ordinary skill in the art, the number of measurements in a measurement M depends on the capability of the GPS unit 101 to receive signals of various satellite systems that have satellites orbiting the globe and the number of satellites that are actually observable at the time the measurements are taken.

In some embodiments, epochs with too few measurements may be filtered out, e.g., not stored. In some embodiments, measurements with too low of a performance, i.e., not meeting a prescribed quality standard, may likewise be filtered out. Quality of the measurements may be gauged, for example, by factors such as the number of received signals; the measurement's minimal, maximal, and averaged signal-to-noise ratio; the number of valid code measurements; and the number of valid phase measurements.

At T₄ a measurement Mₙ is received by host 211 that meets the criterion for not needing to collect more measurements. Those of ordinary skill in the art will readily recognize that such criterion may be having collected measurements of sufficient quality, having collected sufficient measurements, or having collected measurements for a sufficient amount of time. In some embodiments, around ten or more measurements are collected. Typically, the more measurements Mₙ that are collected the better, but as each measurement comes at a power cost implementations must be mindful of the limited power availability in determining how many measurements to collect. Whatever the criterion selected, Mₙ is the last measurement that needs to be collected. Therefore, at T₅, a command is sent from host 211 to GPS unit to turn off GPS unit 101. At T₆, GPS unit 101 turns off, i.e., stops operation.

Note that the spacing between each time T is merely illustrative. For example, the spacing between T₄ and T₅ could be shorter than, and is typically expected to be, the spacing between T₁ and T₂ as shutdown time is shorter than turn on and acquisition time.

Having collected sufficient measurements, at T₇ host 211 transmits a command to connectivity unit 209 to turn on and at T₈ connectivity 211 begins to wireless transmit the collected measurements M₁ to Mₙ toward the intended destination. Upon conclusion of transmission of the measurements at T₉ a stop transmitting command is sent to connectivity 211. Connectivity 211 turns off at T₁₀ in response to the stop transmitting command and thereafter, at T₁₁, IoT GNSS device 100, e.g., host 211, powers off, i.e., goes back to sleep.

Again, the spacing between each time T is merely illustrative. For example, the spacing between T₇ and T₈ is typically dependent on the network connection and association time. Such can vary in dependence on the radio access technology used, e.g. 2G, 3G, 4G, Wi-Fi, Bluetooth, and the like, as well as on the geography, e.g. rural area, suburban, or urban area.

Put another way, in some embodiments host 211 collects data of multiple epochs into a single data package. Note that a single package may be transmitted in multiple packets. Also, epochs with too few measurements, e.g., due to a satellite being blocked for part of the time, may be filtered out and thus are not transmitted. Similarly, measurements with too low performance may be filtered out and thus are not transmitted.

In some embodiments, provided there is sufficient power to operate GPS unit 101 and connectivity unit 209, operation of connectivity unit 209 may partially overlap operation of GPS unit 101. For example, once one or more measurements have been collected by host 211 from GPS unit 101, GPS unit 101 could initiate operation of connectivity unit 209. Once the criterion is met and sufficient measurements have been collected, host 211 could transmit the command to turn off GPS unit 101 while connectivity unit 209 continues to transmit the remaining measurements from host 211.

In some embodiments, where transmission takes place while at least some measurements are still being collected, measurement collection may continue until transmission is ended and even though some collected measurements would not be transmitted. Transmission may be ended simply by IoT GNSS device 100, e.g., host 211, powers off, i.e., going back to sleep.

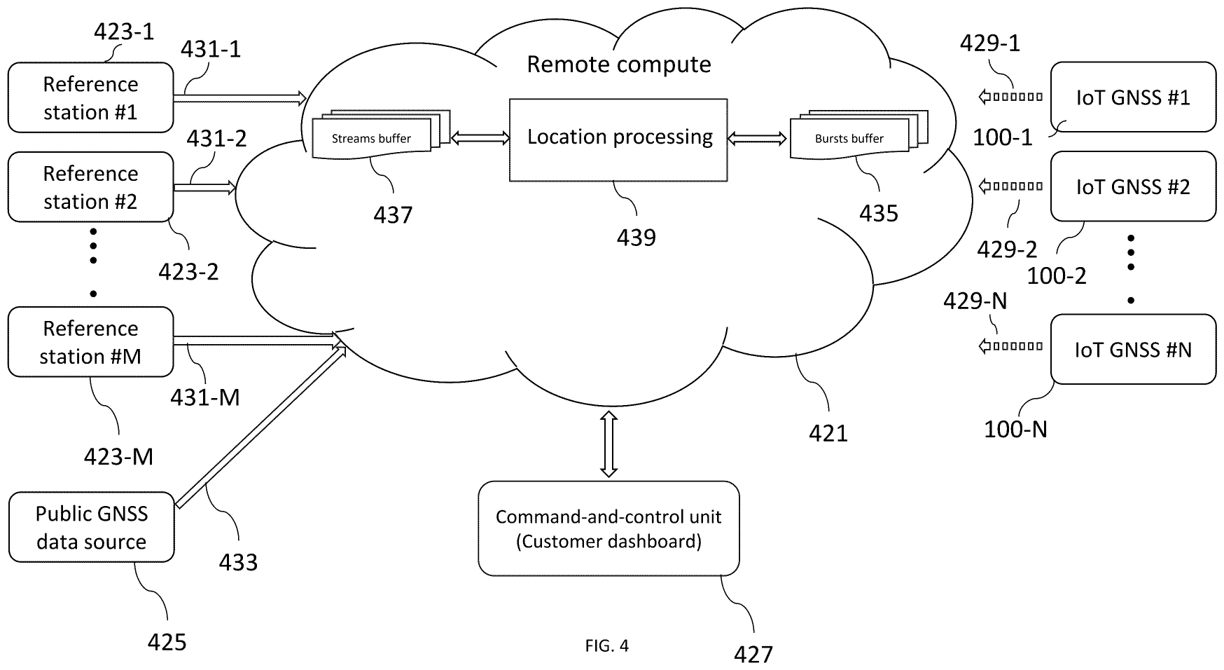

FIG. 4 shows an illustrative system arranged in accordance with the principles of the disclosure for determining a location for an IoT GNSS device that does not determine its own position but instead supplies the GNSS measurements it takes to a remote compute center, e.g., in the cloud, which determines an actual location for the GNSS IoT device. Furthermore, the remote compute center may employ RTK techniques using raw measurements received from one or more nearby static reference stations each of which has a known predetermined accurate location.

Shown in FIG. 4 are IoT GNSS devices 100-1 to 100-N, where N is an integer, remote compute center 421, reference stations 423-1 to 423-M, where M is an integer, public GNSS data source 425, and command and control unit 427 which may also function as customer dashboard. Note that although only one public GNSS data source 425 and only one command and control unit 427 are shown that there in practice may be more than one of each.

Each of IoT GNSS devices 100-1 to 100-N may be a device structured and operated as shown in FIGS. 1-3 and described in connection therewith hereinabove. As such, they each send respective bursts of data 429, i.e., bursts 429-1 through 429-N, where N is an integer, e.g., in packets, containing the measurements taken during an awake period as described hereinabove. Based on the measurements in these bursts, remote compute 421 can determine at least an initial location for each tag. More specifically, location processing 439 within remote compute 421 obtains the measurements of the bursts from the IoT GNSS devices 100 and performs standard positioning calculations for each of IoT GNSS devices 100 to determine their respective locations. In some embodiments, the bursts 429 from each IoT GNSS devices 100 are stored in bursts buffer 435 prior to being supplied to location processing 439.

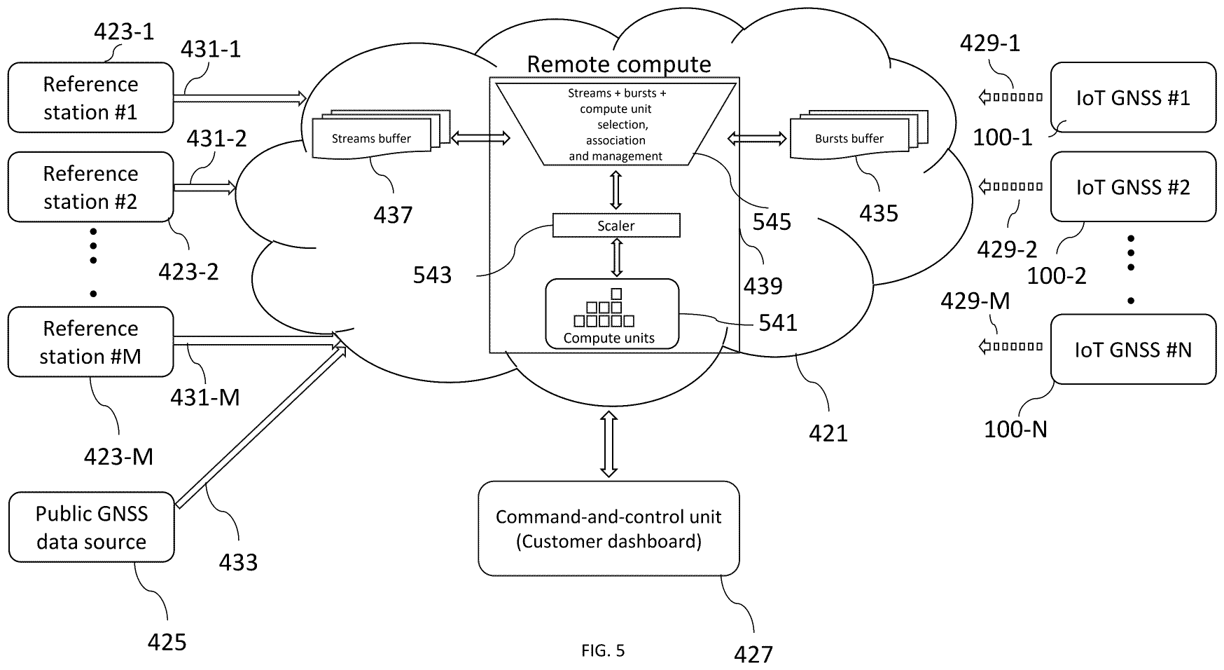

In one embodiment, remote compute 421 may be a network-connected processing arrangement, e.g., a computer or server. In another embodiment, remote compute 421 may be located in the cloud. An example of the structure and operation of remote compute 421 is described hereinbelow in connection with FIG. 5.

The locations determined may be sent to command-and-control unit 427. Command and control unit may be any sort of user device such as a personal computer, a laptop, a tablet computer, a smartphone, a wearable computing device, or any other device capable of receiving and displaying location information for a IoT GNSS device 100. Each improved location determined may be transmitted back to a one of IoT GNSS devices 100 for which it was determined.

Remote compute 421 can also determine improved locations for IoT GNSS devices 100, e.g., using RTK techniques by employing raw measurements received from a static reference stations 423, each of which has a predetermined accurate location. To this end, each of reference stations 423 supplies one of streams 431, which include, streams 431-1 to 431-M, where M is an integer, to remote compute 421. This may be done over any network, e.g., a wireless, cellular or wired network, a local area network (LAN), a wide area network (WAN), a metro area network (MAN), the Internet, the world wide web (WWW), similar networks, and any combination thereof. In addition, each public GNSS data source 425, which are not themselves reference stations, may supply correction data 433 that can be used to improve the location determined by remote compute 421 for each of IoT GNSS devices 100. For example, NASA has a webpage that shares various correction data for the GPS satellites.

In order to determine the improved location, the time at which the measurements from each of IoT GNSS devices 100 whose location is to be improved must be aligned with the time at which the measurements were taken at the reference stations 423 and the information supplied by public GNSS data source 425. To this end, first, it will be appreciated, as is well known, that each measurement captured by each of IoT GNSS devices 100 includes its GPS clock time. Thus, this time is available to remote compute 421. In some embodiments, timing information from host 211 inside each of IoT GNSS devices 100 may be also transmitted and employed. Even though the clock of host 211 may be drifting, the time between each measurement is short enough to be considered to be sufficiently accurate.

More specifically, time tagging of raw GNSS measurements is typically required to remotely calculate accurate positioning using the raw measurements received from IoT GNSS devices 100 in combination with external sources of correction data. In conventional arrangements where the raw GNSS measurements are taken in the same device with a positioning engine, this is easily accomplished. However, when the positioning engine is remote from the source of the raw GNSS measurements, there arises an issue of disparate timing for the raw GNSS measurements and the positioning engine which is making use of external sources of correction data. More specifically, one reason for this challenge is that typically timing in GNSS devices with a positioning engine are driven by the positioning engine in a closed loop feedback fashion.

In one embodiment, to overcome this challenge of not having any or an enabled positioning engine in IoT GNSS devices 100 the host clock is used instead of the GNSS receiver. This is possible, as recognized by the inventors, because, although it is not a perfectly precise clock nor perfectly aligned with the GNSS internal clock, the host clocks at most differ by a very slowly drifting value, i.e., it is almost constant. As such, use of the host clock is sufficient to be able to resolve the unknown timing offset of the measurements in remote compute 421. Also, while the clock information may be somewhat inaccurate, any inaccuracy is ultimately resolved by remote compute 421 as part of the position determination process.

To facilitate the alignment, the bursts 429 from each IoT GNSS devices 100 are stored in bursts buffer 435, which may contain separate logical buffers for each of IoT GNSS devices 100. Each data burst may be disassembled and associated with the time span of the period during which the measurements were taken.

Similarly, the streams of data 431 from reference stations 423 are stored in streams buffer 437. The correction data from public GNSS data source 425 may also be similarly stored. The time span derived from each data burst is used to associate the data from reference stations 423 with the data from IoT GNSS devices 100. In such a manner, location processing 439 may obtain time-aligned raw measurements from bursts buffer 435 and raw measurements from streams buffer 437 to perform improved location determination using a joint computation algorithm, e.g., RTK techniques, which may be implemented by an RTK engine (not shown).

The improved locations determined may be sent to command-and-control unit 427. Each improved location determined may be transmitted back to one of IoT GNSS devices 100 for which it was determined.

Due to the different nature of the communication that remote compute 421 undertakes with IoT GNSS devices 100, reference stations 423, and command and control unit 427, each type of communication may employ a different protocol. For example, bursts 429 may be communicated using a first protocol, measurements from reference stations 423 may be communicated using a second protocol, and location information may be sent to command-and-control unit 427 using a third protocol.

FIG. 5 shows the illustrative system of FIG. 4 with further detail provided for an embodiment in which remote compute 421 is, or includes, cloud processing resources within location processing 439. Location processing 439 may include compute units 541, where there is available more than one compute unit, which may be a fixed number or may be allocated on demand using cloud resources, scaler 543, and controller 545.

Each of compute units 541 provides a position or a corrected position for one of IoT GNSS devices 100. Note that, as the IoT GNSS devices 100 typically operate in an intermittent fashion and not all of them are active at the same time, a compute unit 541 may be assigned at different times to different ones of IoT GNSS devices 100. Also, it will be appreciated that, as a further result of the IoT GNSS devices 100 operating in an intermittent fashion, the number of compute units that are required may vary over time with the number of active ones of IoT GNSS devices 100.

At least one of compute units 541 may perform improved location determination using a joint computation algorithm, e.g., RTK techniques. To that end, one or more of compute units 541 may be configured to perform a joint computation algorithm, e.g., they may have a portion thereof that is configured as an RTK engine.

Given that pricing for the use of cloud resources often depends on the amount of resources required, scaler 543 is responsible to determine how many compute units should be available for allocation at any one time and to cause such number of compute units to be provided by the cloud provider. To that end, the function of scaler 543 is to make sure that there are enough compute units available to handle the number of IoT GNSS devices 100 that are actively providing raw measurements at any one time while attempting to minimize the number of compute units that are requisitioned from the cloud provider so as to keep the cost low. To this end, scaler 543 may look for patterns of receipt of bursts from IoT GNSS devices 100. Scaler 543 may be implemented as a machine learning model executing on a resource of the cloud platform.

Controller 545 performs various functions required to operate location processing 439. These functions include aligning streams from streams buffer 437 with the bursts received from IoT GNSS devices 100 when reference stations or other GNSS data sources are employed, selecting which of compute units 541 will be assigned to process a burst from an IoT GNSS devices 100 whether or not reference stations or other GNSS data sources are employed, and controlling communication with command-and-control unit 427.

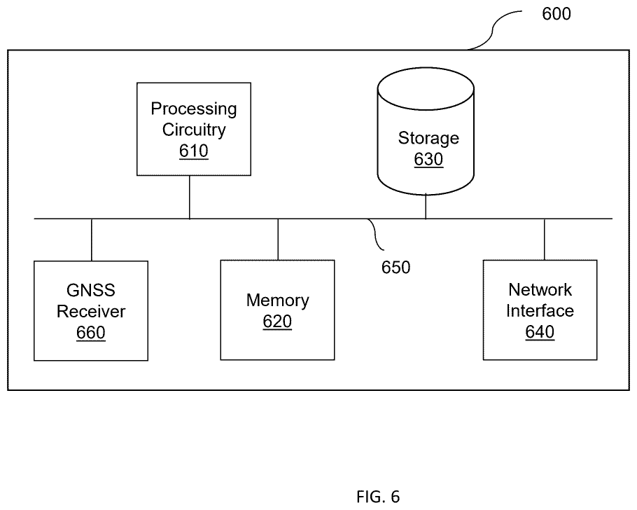

FIG. 6 shows an illustrative system 600 according to an embodiment which can be used to implement any of the devices or processing described herein. For example, it may be used to implement any of IoT GNSS devices 100, reference stations 423, public GNSS data source 425, command-and-control unit 427, and location processing 439, as well as any of compute units 541, scaler 543, and controller 545 included in location processing 439. In some embodiments, system 600 may be implemented as a virtual machine and the like, e.g., when implemented in the cloud. System 600 includes a processing circuitry 610 coupled to a memory 620, a storage 630, and a network interface 640. For those devices, e.g., IoT GNSS devices 100, reference stations 423, and possibly public GNSS data source 425, system 600 also includes optional GNSS receiver 660. In an embodiment, the components of the system 600 may be communicatively connected via a bus 650.

Processing circuitry 610 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

Memory 620 may be volatile, e.g., random access memory, etc., non-volatile, e.g., read-only memory, flash memory, etc., or a combination thereof.

In one configuration, software for implementing one or more embodiments disclosed herein may be stored in storage 630. In another configuration, memory 620 is configured to store such software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by processing circuitry 610, cause the processing circuitry 610 to perform one or more of the various processes described herein.

The storage 630 may be magnetic storage, optical storage, and the like, and may be realized, for example, as flash memory or other memory technology, compact disk-read-only memory (CD-ROM), digital video disks (DVDs), or any other medium which can be used to store the desired information.

The network interface 640 allows the system 600 to communicate with external devices or networks. Network interface 640 may enable wired or wireless communication. For example, IoT public GNSS data source 425.

Optional GNSS receiver 660 at least obtains GNSS measurements. Thus, for example, when system 600 is implemented within one of IoT GNSS devices 100, GNSS receiver 660 obtains the GNSS measurements, e.g., as described in FIG. 3 and may be part of the implementation of GPS 101 of FIGS. 1 and 2. Furthermore, when system 600 is implemented as one of IoT GNSS devices 100, GNSS receiver 660 does not have a positioning engine therein or any positioning engine therein is disabled. However, when system 600 is implemented within one of reference stations 423, public GNSS data source 425, and location processing 439, e.g., within compute units 541, GNSS receiver 660 may include an enabled positioning engine therein.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, firmware executing on hardware, software, software executing on hardware, or any combination thereof. Moreover, the software is implemented tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (CPUs), a memory, and input/output interfaces. The computer platform may also include an operating system and microinstruction code. The various processes and functions described herein may be implemented as either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for operating an intermittently operating Internet of Things (IoT) device having a global navigation satellite system (GNSS) that includes an analog receiver coupled to a GNSS measurements engine, a processing circuit, and a communications interface, the method comprising:
under control of the processing circuit, starting operation of the GNSS to collect GNSS measurements;
under control of the processing circuit, once a first prescribed quantity of measurements are collected, enabling operation of the communications interface;
after the communications interface is enabled, transmitting, via the communications interface, ones of a total prescribed quantity of the collected GNSS measurements, wherein the total prescribed quantity includes the first prescribed quantity; and
under control of the processing circuit, turning off the GNSS once a prescribed condition has been met.

2. The method of claim 1, wherein the prescribed condition is a total prescribed quantity of GNSS measurements have been collected and wherein the total prescribed quantity of GNSS measurements includes the first prescribed quantity of GNSS measurements.

3. The method of claim 1, wherein the prescribed condition is a total prescribed quantity of GNSS measurements have been transmitted and wherein the total prescribed quantity of GNSS measurements includes the first prescribed quantity of GNSS measurements.

4. The method of claim 1, wherein the prescribed condition is powering off of the IoT device.

5. The method of claim 1, wherein at least some GNSS measurements are collected while other GNSS measurements are being transmitted.

6. The method of claim 1, wherein enabling operation of the communications interface further comprises powering on and initializing the communications interface.

7. The method of claim 1, wherein the IoT devices wherein the intermittent operation of the IoT devices is at least one of periodic operation and aperiodic operation.

8. The method of claim 1, wherein the first prescribed quantity of GNSS measurements is a predetermined number of GNSS measurements.

9. The method of claim 1, wherein the first prescribed quantity of GNSS measurements is a number of GNSS measurements collected during a predetermined time period.

10. The method of claim 1, wherein the first prescribed quantity of GNSS measurements is based on a prescribed quality level for the GNSS measurements.

11. The method of claim 1, wherein the first prescribed quantity of GNSS measurements only includes ones of the measurements that at least meet a prescribed quality level for the GNSS measurements.

12. The method of claim 1, wherein the total prescribed quantity of GNSS measurements only includes ones of the measurements that at least meet a prescribed quality level for the GNSS measurements.

13. The method of claim 1, wherein the total prescribed quantity of GNSS measurements is a predetermined number of GNSS measurements.

14. The method of claim 1, wherein the total prescribed quantity of GNSS measurements is a number of GNSS measurements collected during a predetermined time period.

15. The method of claim 1, wherein the ones of the collected GNSS measurements that are transmitted meet a minimum quality threshold.

16. The method of claim 1, wherein GNSS measurements are collected once per epoch.

17. The method of claim 1, wherein the IoT device does not produce a location at the IoT device based on the GNSS measurements.

18. The method of claim 1, wherein the IoT device includes a positioning engine that is at least temporarily not active so that it does not produce a location at the IoT device based on the GNSS measurements while the positioning engine is not active.

19. A method for determining, in a cloud, a current position for an intermittently operating Internet of Things (IoT) device, comprising:
receiving, in the cloud, global navigation satellite system (GNSS) measurements from the IoT device for a time period; and
determining, in the cloud, a current position for the IoT device based on the received GNSS measurements.

20. The method of claim 19, further comprising:
assigning a compute unit in the cloud to perform the determining.

21. The method of claim 19, further comprising:
receiving, at the cloud, remote raw GNSS measurements from at least one reference station; and
determining an enhanced current position for the IoT device based on the determined current position and a version of each of the at least one remote raw GNSS measurements.

22. The method of claim 21, further comprising:
storing in a buffer the received remote raw GNSS measurements; and
employing as the version of each of the at least one remote raw GNSS measurements remote raw GNSS measurements from the buffer that are time aligned to the received GNSS measurements.

23. The method of claim 22, further comprising:
assigning a compute unit in the cloud to perform the determining an enhanced current position for the IoT device.

24. An intermittently operating Internet of Things (IoT) device having a global navigation satellite system (GNSS), comprising:
an analog receiver;
a GNSS measurements engine coupled to the analog receiver,
a processing circuit; and
a communications interface;
wherein the intermittently operating Internet of Things (IoT) device is operable, under control of the processing circuit, to:
start operation of the GNSS to collect GNSS measurements;
enable operation of the communications interface once a first prescribed quantity of measurements are collected; and
transmit, via the communications interface, ones of the collected GNSS measurements.

25. The intermittently operating Internet of Things (IoT) device of claim 24, wherein the intermittently operating Internet of Things (IoT) device is further operable to:
turn off the GNSS once a total prescribed quantity of GNSS measurements have been collected, wherein the total prescribed quantity of GNSS measurements includes the first prescribed quantity of GNSS measurements.

26. The intermittently operating IoT device of claim 24, wherein the intermittently operating IoT device is powered off once a total prescribed quantity of GNSS measurements have been transmitted, wherein the total prescribed quantity of GNSS measurements includes the first prescribed quantity of GNSS measurements.
